(19) United States
(12) Patent Application Publication
(10) Pub. No.: US 2025/0077523 A1
(43) Pub. Date: Mar. 6, 2025

(54) CAPTURING TEMPORARY DATABASE TABLES FOR ANALYZING A DATABASE QUERY

(71) Applicant: International Business Machines Corporation, Armonk, NY (US)

(72) Inventors: Dirk Nakott, Stuttgart (DE); Hans-Jürgen Zeltwanger, Weinsberg (DE); Jens Peter Seifert, Gaertringen (DE); Holger Hellmuth, Bensheim (DE); Jörn Klauke, PETERSBERG (DE); Martin Jungfer, Ostelsheim (DE); Thomas Rech, Rittersheim (DE); Malte Schünemann, Dudenhofen (DE)

(21) Appl. No.: 18/457,379

(22) Filed: Aug. 29, 2023

(51) Int. Cl. G06F 16/2453; G06F 16/22; G06F 16/2458

(52) U.S. Cl. CPC G06F 16/24549; G06F 16/2282; G06F 16/2474

(57) ABSTRACT

Methods for capturing temporary database tables for analyzing a database query are provided. Aspects include obtaining a capture pattern and the database query having a sequence of statements. Aspects also include determining that a first statement of the sequence of statements matches the capture pattern, creating a list of temporary tables based on the first statement, and determining that a second statement of the sequence of statements includes one of a drop, commit, and truncate commands that correspond to a table in the list of temporary tables. Aspects further include creating a copy of the table in the list of temporary tables, generating an updated first statement by replacing a reference to the table in the list of temporary tables with a reference to the copy of the table, removing the table from the list of temporary tables, and executing the database query by performing the sequence of statements.

### BACKGROUND

The present disclosure generally relates to analyzing the performance of a database query, and more specifically, to methods and systems for methods for capturing temporary database tables for analyzing a database query.

Database servers and distributed database servers are utilized by many organizations to collect and store data generated by various parts of their organizations, such as sales data, production data, and the like. These database servers are frequently queried via Online Analytical Processing (OLAP) system to obtain data regarding the operation of the organization for reporting, performing analytics, forecasting and the like. Often, data warehouse systems use techniques to split a large OLAP request into several small SQL sub-queries. The result of the sub-queries is temporarily persisted in temporary database tables on the data warehouse system. As used herein, temporary database tables refer to database tables that are created, managed, and dropped by the data warehouse system, also referred to herein as the OLAP processor. These temporary tables are used to store data, which have temporary characteristics from the application point of view. Another type of temporary database table is a declared global temporary table (DGTT), also known as session table. Depending on the definition, the rows of the session tables are preserved or deleted on commit, or the table is dropped on commit. In this context, “deleted” means that all rows of the table are deleted, which is functional identical to truncate.

When performance problems arise with the execution of a database query, the analysis of the execution plan of SQL statements containing temporary database tables is difficult because the temporary database tables are truncated, reused, or dropped. Without having the structure and content of the temporary database tables, analysis of the execution of the SQL statement is not possible.

### SUMMARY

Embodiments of the present disclosure are directed to computer-implemented methods for capturing temporary database tables for analyzing a database query. According to an aspect, a computer-implemented method includes obtaining a capture pattern, obtaining the database query, where the database query includes a sequence of statements, and determining that a first statement of the sequence of statements matches the capture pattern. The method also includes creating a list of temporary tables based on the first statement, determining that a second statement of the sequence of statements includes one of a drop, commit, and truncate commands that correspond to a table in the list of temporary tables, and creating a copy of the table in the list of temporary tables. The method further includes generating an updated first statement by replacing a reference to the table in the list of temporary tables with a reference to the copy of the table, removing the table from the list of temporary tables, and executing the database query by performing the sequence of statements.

Embodiments also include computer systems and computer program products for capturing temporary database tables for analyzing a database query.

Additional technical features and benefits are realized through the techniques of the present disclosure. Embodiments and aspects of the disclosure are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the present disclosure are apparent from the following detailed description taken in conjunction with the accompanying drawings in which:

FIG. 1 depicts a block diagram of an example computer system for use in conjunction with one or more embodiments of the present disclosure;

FIG. 2 depicts a block diagram of a system for capturing temporary database tables for analyzing a database query in accordance with one or more embodiments of the present disclosure;

FIG. 3 depicts a flowchart of a method for processing a database query and capturing temporary database tables in accordance with one or more embodiments of the present disclosure;

FIG. 4 depicts a flowchart of a method for capturing temporary database tables for analyzing a database query in accordance with one or more embodiments of the present disclosure; and

FIG. 5 depicts a flowchart of a method for managing captured temporary database tables in accordance with one or more embodiments of the present disclosure.

### DETAILED DESCRIPTION

As discussed above, when performance problems arise with the execution of a database query, the analysis of the execution plan of SQL statements containing temporary database tables is difficult because the temporary database tables are truncated, reused, or dropped. Exemplary embodiments include methods, systems, and computer program products for capturing temporary database tables for analyzing a database query. In exemplary embodiments, a database server is provided that includes a capture component that is configured to capture the data of temporary database tables before the temporary database tables are truncated or dropped, or the transaction commits. The captured data is stored into new database tables that are stored and managed by the capture component. In addition, the capture component is configured to identify an SQL statement that contains references to the temporary database tables and to generate and store a new SQL statement based on the captured SQL statement where the names of temporary database tables are replaced by the names of the newly created tables. In exemplary embodiments, the generated SQL statement together with the newly created tables can be used for performance analysis after the temporary database tables are truncated or dropped or the transaction commits.

In exemplary embodiments, a capture pattern is utilized to trigger the storage of the temporary tables. The capture pattern may be defined by a database administrator. Once the capture pattern is set, the capture component is configured to check each SQL statement of a database query to determine the SQL statement matches the capture pattern. Based on determining that the SQL statement matches the capture pattern, the capture component creates a list of tables involved in the SQL statement or in underlying views, which may include both regular data tables and temporary database tables. In exemplary embodiments, the runtime of the SQL statement matching the capture pattern is obtained and stored.

Various aspects of the present disclosure are described by narrative text, flowcharts, block diagrams of computer systems, and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as capturing temporary database tables for analyzing a database query (block 150). In addition to block 150, computing environment 100 includes, for example, computer 101, wide area network (WAN) 102, end user device (EUD) 103, remote server 104, public Cloud 105, and private Cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI), device set 123, storage 124, and Internet of Things (IoT) sensor set 125), and network module 115. Remote server 104 includes remote database 132. Public Cloud 105 includes gateway 130, Cloud orchestration module 131, host physical machine set 142, virtual machine set 143, and container set 144.

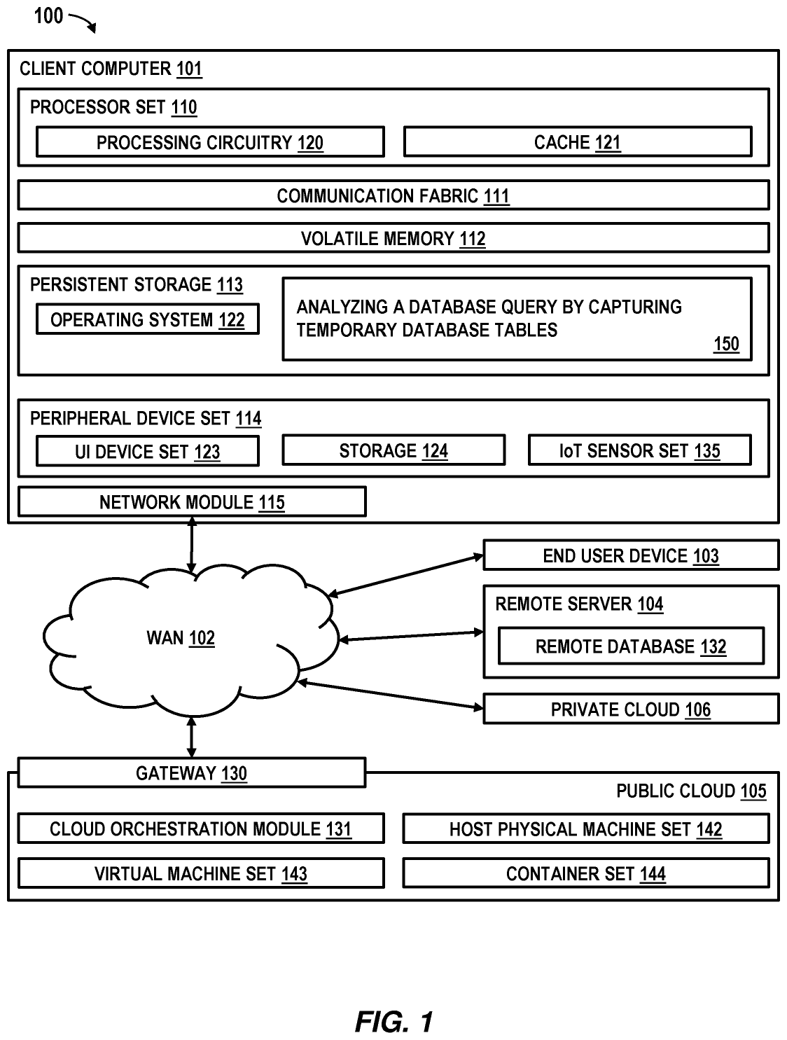

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 132. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a Cloud, even though it is not shown in a Cloud in FIG. 1. On the other hand, computer 101 is not required to be in a Cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collects and store helpful and useful data for use by other computers, such as computer 101. For example, in a hypothetical case where computer 101 is designed and programmed to provide a recommendation based on historical data, then this historical data may be provided to computer 101 from remote database 132 of remote server 104.

PUBLIC CLOUD 105 is any computer system available for use by multiple entities that provides on-demand availability of computer system resources and/or other computer capabilities, especially data storage (Cloud storage) and computing power, without direct active management by the user. Cloud computing typically leverages sharing of resources to achieve coherence and economies of scale. The direct and active management of the computing resources of public Cloud 105 is performed by the computer hardware and/or software of Cloud orchestration module 131. The computing resources provided by public Cloud 105 are typically implemented by virtual computing environments that run on various computers making up the computers of host physical machine set 132, which is the universe of physical computers in and/or available to public Cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 131 manages the transfer and storage of images, deploys new instantiations of VCEs and manages active instantiations of VCE deployments. Gateway 130 is the collection of computer software, hardware, and firmware that allows public Cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public Cloud 105, except that the computing resources are only available for use by a single enterprise. While private Cloud 106 is depicted as being in communication with WAN 102, in other embodiments a private Cloud may be disconnected from the internet entirely and only accessible through a local/private network. A hybrid Cloud is a composition of multiple Clouds of different types (for example, private, community or public Cloud types), often respectively implemented by different vendors. Each of the multiple Clouds remains a separate and discrete entity, but the larger hybrid Cloud architecture is bound together by standardized or proprietary technology that enables orchestration, management, and/or data/application portability between the multiple constituent Clouds. In this embodiment, public Cloud 105 and private Cloud 106 are both part of a larger hybrid Cloud.

One or more embodiments described herein can utilize machine learning techniques to perform prediction and or classification tasks, for example. In one or more embodiments, machine learning functionality can be implemented using an artificial neural network (ANN) having the capability to be trained to perform a function. In machine learning and cognitive science, ANNs are a family of statistical learning models inspired by the biological neural networks of animals, and in particular the brain. ANNs can be used to estimate or approximate systems and functions that depend on a large number of inputs. Convolutional neural networks (CNN) are a class of deep, feed-forward ANNs that are particularly useful at tasks such as, but not limited to analyzing visual imagery and natural language processing (NLP). Recurrent neural networks (RNN) are another class of deep, feed-forward ANNs and are particularly useful at tasks such as, but not limited to, unsegmented connected handwriting recognition and speech recognition. Other types of neural networks are also known and can be used in accordance with one or more embodiments described herein.

ANNs can be embodied as so-called “neuromorphic” systems of interconnected processor elements that act as simulated “neurons” and exchange “messages” between each other in the form of electronic signals. Similar to the so-called “plasticity” of synaptic neurotransmitter connections that carry messages between biological neurons, the connections in ANNs that carry electronic messages between simulated neurons are provided with numeric weights that correspond to the strength or weakness of a given connection. The weights can be adjusted and tuned based on experience, making ANNs adaptive to inputs and capable of learning. For example, an ANN for handwriting recognition is defined by a set of input neurons that can be activated by the pixels of an input image. After being weighted and transformed by a function determined by the network's designer, the activation of these input neurons are then passed to other downstream neurons, which are often referred to as “hidden” neurons. This process is repeated until an output neuron is activated. The activated output neuron determines which character was input.

A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

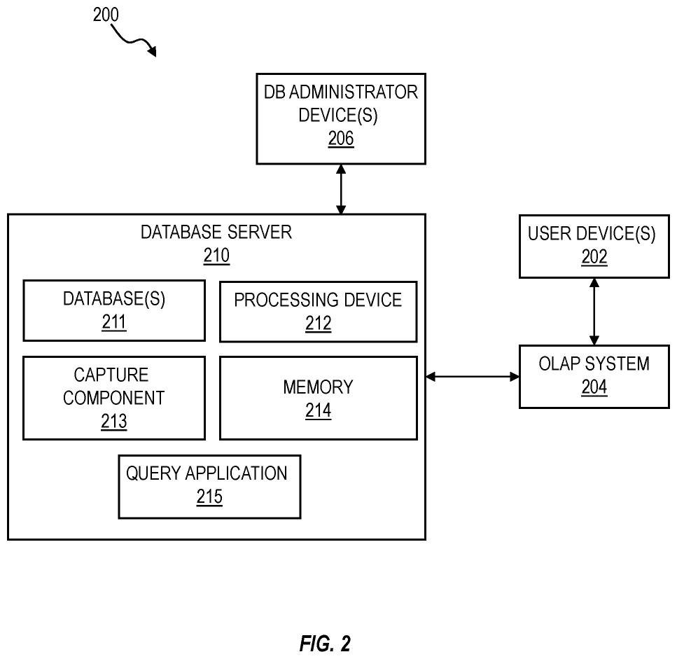

Referring now to FIG. 2, a block diagram of a system 200 for capturing temporary database tables for analyzing a database query in accordance with one or more embodiments of the present disclosure is shown. As illustrated, the system 200 includes a user device 202 that is configured to provide a query to an Online Analytical Processing (OLAP) system 204. The OLAP system 204 is configured to create a database query that includes a plurality of statements, such as Structured Query Language (SQL) statements based on the query received from the user device 202. The OLAP system 204 is configured is also configured to provide the database query, including a plurality of statements, to a database server 210 for processing. The database server 210 includes one or more databases 211, a processing device 212, a capture component 213, a memory 214, and a query application 215. In exemplary embodiments, the query application 215 is configured to execute, via processing device 212, the database query received from the OLAP system 204 to extract data from the one or more databases 211. In exemplary embodiments, the memory 214 is configured to store tables, including temporary tables, that are created/used by the query application 215 during execution of the database query received from the OLAP system 204. In exemplary embodiments, the capture component 213 is configured to capture, manage and store configuration information and data related to the capture of temporary database tables in the memory 214. In exemplary embodiments, the capturing of the capturing of configuration information and data related to the temporary database tables is transparent to the query application 215, which executes the SQL statements and does not require any change to the query application 215.

The system 200 also includes a database administrator device 206 that is configured to perform performance analysis on the database server. In exemplary embodiments, the database administrator device 206 is configured to provide a capture pattern to the capture component 213. In exemplary embodiments, the capture pattern is an SQL statement or a part of a SQL statement having a specified format, which includes references to one or more temporary tables used by the SQL statement. In exemplary embodiments, one or more of the user devices 202, the database administrator device 206, the OLAP system 204, and the database server 210 may be embodied in a computer 101, such as the one shown in FIG. 1.

As mentioned above, the OLAP system 204 is configured to generate a database query that includes a plurality of SQL statements. Two examples of such database queries are shown below. In Example 1, SQL statement 5 causes returns the result to the OLAP system 204 and SQL statement 6 and 7 cause the deletion of the data in TEMP_TAB1 and TEMP_TAB2. The temporary database tables no longer exist (in case of DROP) or are candidates for reuse and do not contain data anymore (in case of TRUNCATE).

### Example 1

1. CREATE TEMP_TAB1
2. INSERT INTO TEMP_TAB1 SELECT
   FROM <data warehouse table 1>
   JOIN <data warehouse table 2>
3. CREATE TEMP_TAB2
4. INSERT INTO TEMP_TAB1 SELECT
   FROM <data warehouse table 3>
   JOIN <data warehouse table 4>
5. SELECT FROM TEMP_TAB1 JOIN TEMP_TAB2 JOIN <data warehouse table 5>
6. DROP TABLE TEMP_TAB1
7. TRUNCATE TEMP_TAB2

### Example 2

1. CREATE GLOBAL TEMPORARY TABLE TEMP_TAB1 ON COMMIT DROP TABLE
2. INSERT INTO TEMP_TAB1 SELECT
   FROM <data table 1>
   JOIN <data table 2>
3. SELECT FROM TEMP_TAB1 JOIN <data table 3>
4. COMMIT

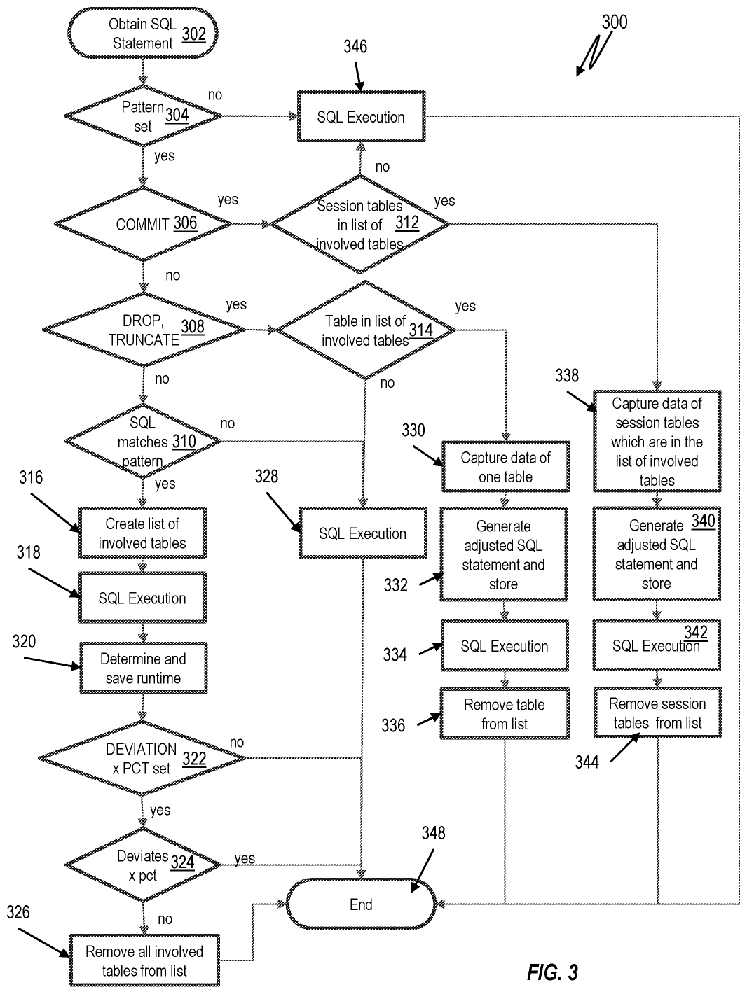

Referring now to FIG. 3, a flowchart of a method for processing a database query and capturing temporary database tables in accordance with one or more embodiments of the present disclosure is shown. In one embodiment, the method 300 is performed for every SQL statement by a database server 210 such as the one shown in FIG. 2. At block 302, the method 300 includes obtaining an SQL statement of a database query. Next, at decision block 304, the method 300 includes determining whether a capture pattern has been set. Based on a determination that no capture pattern has been set, the method 300 proceeds to block 346 and executes the SQL statement. Based on a determination that a capture pattern has been set, the method 300 proceeds to decision block 304 and determines whether the SQL statement is a COMMIT statement.

Based on a determination that the SQL statement is not a COMMIT statement, the method 300 proceeds to decision block 308. Based on a determination that the SQL statement is a COMMIT statement, the method 300 proceeds to decision block 312 and determines whether a temporary table—in this case a session table—referenced by the SQL statement is in a list of involved tables. Based on a determination that the temporary table referenced by the SQL statement is not in the list of involved tables, the method 300 proceeds to block 346 and executes the SQL statement. Based on a determination that the temporary table referenced by the SQL statement is in the list of involved tables, the method 300 proceeds to block 338 and includes capturing data of the temporary table—in this case a session table—referenced by the SQL statement that are in the list of involved tables and storing the captured data in a new table having a new name. Next, as shown at block 340, the method 300 includes generating/updating an SQL statement based on the SQL statement that matches the capture pattern by replacing a reference to the temporary table with a reference to the new table name. In exemplary embodiments, the generated/updated SQL statement is saved in the capture component for analysis by the database administrator. At block 342, the method 300 includes executing the SQL statement (e.g., the COMMIT). Next, as shown at block 344, the method 300 includes removing the temporary tables from the list of involved tables.

At decision block 308, the method 300 determines whether the SQL statement is one of a DROP or TRUNCATE statement. Based on a determination that the SQL statement is one of a DROP or TRUNCATE statement, the method 300 proceeds to decision block 314 and determines whether a temporary table—in this case the table name part of the DROP or TRUNCATE statement—referenced by the SQL statement is in a list of involved tables. Based on a determination that the temporary table referenced by the SQL statement is not in the list of involved tables, the method 300 proceeds to block 328 and executes the SQL statement. Based on a determination that the temporary table referenced by the SQL statement is in the list of involved tables, the method 300 proceeds to block 330 and includes capturing data of the temporary table referenced by the SQL statement that are in the list of involved tables and storing the captured data in a new table having a new name. Next, as shown at block 332, the method 300 includes generating/updating an SQL statement based on the SQL statement that matches the capture pattern by replacing a reference to the temporary table with a reference to the new table name. In exemplary embodiments, the generated/updated SQL statement is saved in the capture component for analysis by the database administrator. At block 334, the method 300 includes executing the SQL statement (e.g., the DROP or TRUNCATE). Next, as shown at block 336, the method 300 includes removing the temporary table from the list of involved tables.

At decision block 310, the method 300 determines whether the SQL statement matches the capture pattern. Based on a determination that the SQL statement matches the capture pattern, the method proceeds to block 316 and creates a list of involved tables, which are temporary tables that are referenced by the SQL statement. Otherwise, the method 300 proceeds to block 328 and executes the SQL statement. As shown at block 318, the method 300 includes executing the SQL statement, e.g., the SQL statement that matched the capture pattern. Next, as shown at block 320, the method 300 includes determining and saving a runtime of the SQL statement that matched the capture pattern.

At decision block 322, the method 300 includes determining whether a deviation threshold percentage level has been set. If a deviation threshold percentage level has not been set, the method 300 proceeds to block 348 and ends if the SQL statement was the last statement in the database transaction. If the SQL statement was not the last statement in the database transaction, the method beings again at block 302 and processes the next SQL statement in the database transaction. Based on a determination that a deviation threshold percentage level has been set, the method 300 proceeds to decision block 324 and determine whether the captured runtime for the SQL statement exceeds the deviation threshold percentage level. Based on determining that the captured runtime for the SQL statement exceeds the deviation threshold percentage level, the method proceeds to block 348. Based on a determination that the captured runtime for the SQL statement does not exceed the deviation threshold percentage level, the method 300 proceeds to block 326 and removes all of the tables from the list of involved tables.

In one example, the method 300 is used to process a database query as shown in Example 1 above and a database administrator has set a capture pattern to be ‘SELECT FROM TEMP_TAB1 JOIN TEMP_TAB*’ FOR ‘DROP, TRUNCATE’. In exemplary embodiments, the capture pattern can be a SQL statement, a part of a SQL statement, a string containing wild cards etc. During processing of the SQL statements 1 through 4, the method proceeds through decision blocks 304, 306, 308, and 310 to block 328 and executes each SQL statement.

During the processing SQL statement 5, the method proceeds through decision blocks 304, 306, 308, and 310 to block 316, where a list of tables including TEMP_TAB1, TEMP_TAB2, <data warehouse table 5> is created.

During the processing SQL statement 6, the method proceeds through decision block 304, 306 and 308. At decision block 314 the table list is checked for TEMP_TAB1 and since TEMP_TAB1 is contained in the list the method proceeds to block 330 where the capture component copies TEMP_TAB1 into TEMP_TAB1_save. At block 332, the capture component updates the SQL statement 5 from “SELECT FROM TEMP_TAB1 JOIN TEMP_TAB2 JOIN <data warehouse table 5>” to “SELECT FROM TEMP_TAB1 save JOIN TEMP_TAB2 JOIN <data warehouse table 5>”. Then, at block 334, the DROP SQL statement is executed, which deletes TEMP_TAB1. At block 336, the method includes removing TEMP_TAB1 from the list of involved tables.

During the processing SQL statement 7, the method proceeds through decision block 304, 306 and 308. At decision block 314 the table list is checked for TEMP_TAB2 and since TEMP_TAB2 is contained in the list the method proceeds to block 330 where the capture component copies TEMP_TAB2 into TEMP_TAB2_save. At block 332, the capture component updates the SQL statement 5 from “SELECT FROM TEMP_TAB1_save JOIN TEMP_TAB2 JOIN <data warehouse table 5>” to “SELECT FROM TEMP_TAB1 save JOIN TEMP_TAB2 save JOIN <data warehouse table 5>”. Then, at block 334, the TRUNCATE SQL statement is executed, which deletes the content of TEMP_TAB2. At block 336, the method includes removing TEMP_TAB2 from the list of involved tables.

In exemplary embodiments, after the database administrator set the capture pattern of ‘SELECT FROM TEMP_TAB1 JOIN TEMP_TAB*’ FOR ‘DROP, TRUNCATE’ and executed the database query shown in Example 1, the capture component would include the SQL statement “SELECT FROM TEMP_TAB1 save JOIN TEMP_TAB2_save JOIN <data warehouse table 5>” and the capture component would include both SELECT FROM TEMP_TAB1_save JOIN TEMP_TAB2_save. As a result, the database administrator could re-execute the stored SQL statement to check runtime performance of the SQL statement.

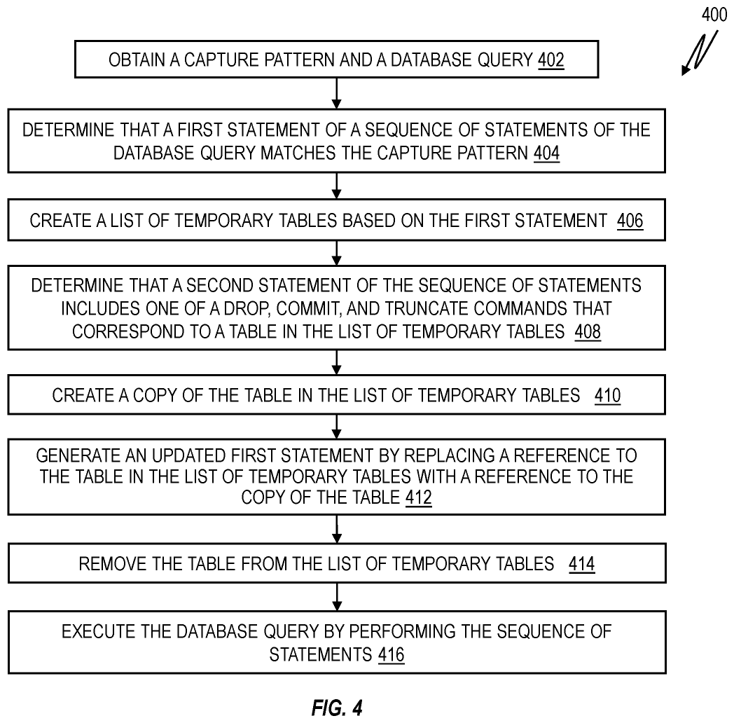

Referring now to FIG. 4, a flowchart of a method for capturing temporary database tables for analyzing a database query in accordance with one or more embodiments of the present disclosure is shown. In one embodiment, the method 300 is performed by a database server 210 such as the one shown in FIG. 2. At block 302, the method 300 includes obtaining a capture pattern and a database query to be analyzed. In exemplary embodiments, the capture pattern is an SQL statement or a part of a SQL statement that includes references to one or more temporary tables and the database query includes a plurality of SQL statements. Next, as shown at block 404, the method 400 includes determining whether a first statement of a sequence of statements of the database transaction matches the capture pattern. Based on determining whether a first statement of a sequence of statements of the database query matches the capture pattern, the method 400 includes creating a list of temporary tables based on the first statement.

Next, as shown at block 408, the method 400 includes determining that a second statement of the sequence of statements includes one of a drop, commit, and truncate commands that correspond to a table in the list of temporary tables. Based on determining that a second statement of the sequence of statements includes one of a drop command, a commit command, and truncate command that correspond to a table in the list of temporary tables, the method 400 includes creating a copy of the table in the list of temporary tables. Next, at block 412, the method 400 includes generating an updated first statement by replacing a reference to the table in the list of temporary tables with a reference to the copy of the table. In an exemplary embodiment, the updated first statement, also referred to herein as a generated SQL statement, is stored in the capture component and includes a retention period for the updated SQL statement and its associated copies of the temporary tables. The method 400 also includes removing the table from the list of temporary tables, as shown at block 414. The method 400 concludes at block 416 by executing the database query by performing the sequence of statements.

In exemplary embodiments, the capture pattern is used to determine a SQL statement to trigger the capture of temporary tables, and the capture pattern can also be used to determine when to capture data of temporary database tables. In one embodiment, the capture pattern can be configured to always capture data of temporary database tables if DROP, TRUNCATE or COMMIT occurs for one of the tables in the list of involved tables. In another embodiment the capture pattern can be configured to trigger the capture of temporary database tables based on a determination that the runtime of SQL statement (e.g., the SQL statement that matches the capture pattern) deviates from the average runtime of that SQL statement by more than a deviation threshold percentage level at execution of DROP, TRUNCATE or COMMIT. In embodiments, the capture component replaces the names of the temporary database tables in the captured SQL statement with the names of the newly created tables and stores the generated SQL statement. To ensure that data of a temporary database tables is only captured once, the table is removed from the list of involved tables after the replacement in the generated SQL statement. In one embodiment, the capture pattern can be defined as “SET CURRENT CAPTURE PATTERN <regular expression> FOR <action list>” where <action list> includes one or more of “DROP, TRUNCATE, COMMIT, DEVIATION x PCT.”

In exemplary embodiments, the current runtime, the average runtime, the original SQL statement, the generated SQL statement containing the newly created table names, the list of involved tables in the original SQL statement are stored in the capture component. In exemplary embodiments, capturing data of temporary database tables is done in different methods. At TRUNCATE, the temporary database table can be renamed into the newly created table and a new table is created with the name and the structure of the previous temporary database table. At DROP, the temporary database table is renamed into the newly created table. At COMMIT, the capture component preserves the data of the temporary database table in a buffer pool if space in the buffer pool is available or persists the data into the newly created table.

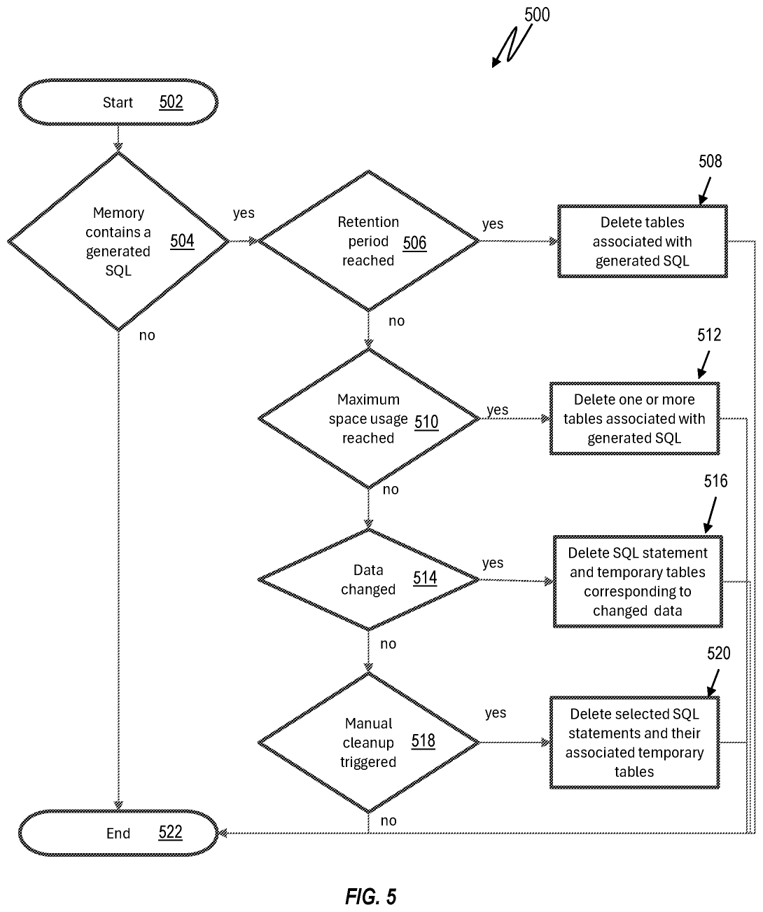

Referring now to FIG. 5, a flowchart of a method for managing captured temporary database tables in accordance with one or more embodiments of the present disclosure is shown. In one embodiment, the method 500 is performed by database server 210 such as the one shown in FIG. 2. The method 500 begins at block 502 and proceeds to decision block 504 where a determination is made whether a generated SQL statement is present in the capture component. If the capture component does not include a generated SQL statement, the method 500 proceeds to block 522 and ends. Based on a determination that the capture component does include a generated SQL statement, the method 500 proceeds to decision block 506. At decision block 506, a determination is made whether a retention period associated with the generated SQL statement has been reached. Based on a determination that the retention period associated with the generated SQL statement has been reached, the method 500 proceeds to block 508 and temporary tables associated with the generated SQL statement are deleted. Based on a determination that the retention period associated with the generated SQL statement has not been reached, the method 500 proceeds to decision block 510.

At decision block 510, the method 500 includes determining whether a maximum storage space allocated to the generated SQL statements and their associated temporary tables has been reached. If the maximum storage space has been reached, the method 500 proceeds to block 512 and one or more of the SQL statements and their associated temporary tables stored in the memory are deleted. In one embodiment, the SQL statements and their associated temporary tables are selected for deletion based on the date that the SQL statements were generated (e.g., the oldest SQL statements and tables are deleted first). Based on a determination that the maximum storage space has not been reached, the method 500 proceeds to decision block 514.

At decision block 514, the method 500 includes determining whether a data table (that is not one of the temporary data tables) associated with the SQL statement has been changed. For example, a determination is made whether <data warehouse table 5> in SQL statement 5 of Example 1 above has been changed. If a data table associated with the SQL statement has been changed, the method 500 proceeds to block 516 and the SQL statement and its associated temporary tables that correspond to the changed data are deleted. Based on a determination that no data table associated with the SQL statement has been changed, the method 500 proceeds to decision block 518.

At decision block 518, the method 500 includes determining whether a manual cleanup of the generated SQL statement and their associated temporary tables has been triggered. If a manual cleanup of the generated SQL statement and their associated temporary tables has been triggered, the method 500 proceeds to block 520 and deleted the selected SQL statements and their associated temporary tables. Otherwise, the method 500 proceeds to block 522 and ends.

Various embodiments are described herein with reference to the related drawings. Alternative embodiments can be devised without departing from the scope of the present disclosure. Various connections and positional relationships (e.g., over, below, adjacent, etc.) are set forth between elements in the following description and in the drawings. These connections and/or positional relationships, unless specified otherwise, can be direct or indirect, and the present disclosure is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

One or more of the methods described herein can be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

For the sake of brevity, conventional techniques related to making and using aspects of the present disclosure may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

In some embodiments, various functions or acts can take place at a given location and/or in connection with the operation of one or more apparatuses or systems. In some embodiments, a portion of a given function or act can be performed at a first device or location, and the remainder of the function or act can be performed at one or more additional devices or locations.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The present disclosure has been presented for purposes of illustration and description, but is not intended to be exhaustive or limited to the form disclosed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the disclosure for various embodiments with various modifications as are suited to the particular use contemplated.

The diagrams depicted herein are illustrative. There can be many variations to the diagram or the steps (or operations) described therein without departing from the spirit of the disclosure. For instance, the actions can be performed in a differing order or actions can be added, deleted or modified. Also, the term “coupled” describes having a signal path between two elements and does not imply a direct connection between the elements with no intervening elements/connections therebetween. All of these variations are considered a part of the present disclosure.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e. one, two, three, four, etc. The terms “a plurality” are understood to include any integer number greater than or equal to two, i.e. two, three, four, five, etc. The term “connection” can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The present disclosure may be a system, a method, and/or a computer program product at any possible technical detail level of integration. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the present disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

1. A method for capturing temporary database tables for analyzing a database query, the method comprising:
obtaining a capture pattern;
obtaining the database query, wherein the database query includes a sequence of statements;
determining that a first statement of the sequence of statements matches the capture pattern;
creating a list of temporary tables based on the first statement;
based on determining that a second statement of the sequence of statements includes one of a drop, commit, and truncate commands that correspond to a table in the list of temporary tables:
creating a copy of the table in the list of temporary tables;
generating an updated first statement by replacing a reference to the table in the list of temporary tables with a reference to the copy of the table; and
removing the table from the list of temporary tables; and
executing the database query by performing the sequence of statements.

2. The method of claim 1, further comprising obtaining and storing a runtime for executing the database query.

3. The method of claim 2, further comprising:
obtaining an average runtime for executing the database query;
obtaining a runtime deviation percentage;
determining that a current runtime does not exceed the average runtime by more than the runtime deviation percentage; and
removing tables referenced by the first statement from the list of temporary tables.

4. The method of claim 1, wherein the capture pattern includes a structured query language statement that includes at least one temporary database table.

5. The method of claim 4, wherein the capture pattern is received from a database administrator.

6. The method of claim 1, further comprising storing the updated first statement for a retention period.

7. The method of claim 6, further comprising deleting the updated first statement and the copy of the table after the retention period.

8. A computer program product having one or more computer readable storage media having computer readable program code collectively stored on the one or more computer readable storage media, the computer readable program code being executed by a processor of a computer system to cause the computer system to perform operations comprising:
obtaining a capture pattern;
obtaining a database query, wherein the database query includes a sequence of statements;
determining that a first statement of the sequence of statements matches the capture pattern;
creating a list of temporary tables based on the first statement;
based on determining that a second statement of the sequence of statements includes one of a drop, commit, and truncate commands that correspond to a table in the list of temporary tables:
creating a copy of the table in the list of temporary tables;
generating an updated first statement by replacing a reference to the table in the list of temporary tables with a reference to the copy of the table; and
removing the table from the list of temporary tables; and
executing the database query by performing the sequence of statements.

9. The computer program product of claim 8, wherein the operations further comprise obtaining and storing a runtime for executing the database query.

10. The computer program product of claim 9, wherein the operations further comprise:
obtaining an average runtime for executing the database query;
obtaining a runtime deviation percentage;
determining that a current runtime does not exceed the average runtime by more than the runtime deviation percentage; and
removing tables referenced by the first statement from the list of temporary tables.

11. The computer program product of claim 8, wherein the capture pattern includes a structured query language statement that includes at least one temporary database table.

12. The computer program product of claim 11, wherein the capture pattern is received from a database administrator.

13. The computer program product of claim 8, wherein the operations further comprise storing the updated first statement for a retention period.

14. The computer program product of claim 13, further comprising deleting the updated first statement and the copy of the table after the retention period.

15. A computing system comprising:
a processor;
a memory coupled to the processor; and
one or more computer readable storage media coupled to the processor, the one or more computer readable storage media collectively containing instructions that are executed by the processor via the memory to cause the processor to perform operations comprising:
obtaining a capture pattern;
obtaining a database query, wherein the database query includes a sequence of statements;
determining that a first statement of the sequence of statements matches the capture pattern;
creating a list of temporary tables based on the first statement;
based on determining that a second statement of the sequence of statements includes one of a drop, commit, and truncate commands that correspond to a table in the list of temporary tables:
creating a copy of the table in the list of temporary tables;
generating an updated first statement by replacing a reference to the table in the list of temporary tables with a reference to the copy of the table; and
removing the table from the list of temporary tables; and
executing the database query by performing the sequence of statements.

16. The computing system of claim 15, wherein the operations further comprise obtaining and storing a runtime for executing the database query.

17. The computing system of claim 16, wherein the operations further comprise:
obtaining an average runtime for executing the database query;
obtaining a runtime deviation percentage;
determining that a current runtime does not exceed the average runtime by more than the runtime deviation percentage; and
removing tables referenced by the first statement from the list of temporary tables.

18. The computing system of claim 15, wherein the capture pattern includes a structured query language statement that includes at least one temporary database table.

19. The computing system of claim 18, wherein the capture pattern is received from a database administrator.

20. The computing system of claim 15, wherein the operations further comprise storing the updated first statement for a retention period.
